(19) United States
(12) Patent Application Publication
(10) Pub. No.: US 2025/0304842 A1
(43) Pub. Date: Oct. 2, 2025

(54) COMPOSITION FOR BIMETALLIC CMP

(71) Applicant: ENTEGRIS, INC., Billerica, MA (US)

(72) Inventors: Kevin P. Dockery, Aurora, IL (US); Na Zhang, Naperville, IL (US); Bosky Soni, North Aurora, IL (US); Tala Zubi, Tinley Park, IL (US); Jason Seabold, Oswego, IL (US); Ali Jawaid, Naperville, IL (US)

(21) Appl. No.: 19/089,578

(22) Filed: Mar. 25, 2025

Related U.S. Application Data
(60) Provisional application No. 63/572,028, filed on Mar. 29, 2024.

(51) Int. Cl. C09K 3/14

(52) U.S. Cl. CPC C09K 3/1463; C09K 3/1436

(57) ABSTRACT

A chemical mechanical polishing composition comprises, consists of, or consists essentially of a liquid carrier, abrasive particles dispersed in the liquid carrier, an iron-containing accelerator, a stabilizer bound to the iron-containing accelerator, at least one inhibitor of tungsten etching, the inhibitor of tungsten etching including at least one nitrogen containing group, and a substituted piperazine compound.

### BACKGROUND OF THE INVENTION

Chemical mechanical polishing (CMP) compositions and methods for polishing (or planarizing) the surface of a substrate are well known. Polishing compositions (also known as polishing slurries, CMP slurries, and CMP compositions) for polishing metal layers (such as tungsten) on a semiconductor substrate may include abrasive particles (e.g., including silica particles) dispersed in an aqueous carrier and various chemical additives such as an oxidizer (e.g., hydrogen peroxide), a rate accelerator (e.g., a catalyst), a corrosion inhibitor, and a pH buffer.

As transistor sizes continue to shrink, the use of conventional metal interconnect technology has become increasingly challenging. Recently, molybdenum has emerged as a candidate metal for advanced node applications, for example, to replace or supplement copper and/or tungsten in the lower metal layers of the interconnect structure (e.g., in the M1, M2, and/or M3 layers). Moreover, molybdenum may also be used as a liner for tungsten plugs and interconnects.

As noted above, CMP compositions commonly employ an oxidizer such as hydrogen peroxide. Tungsten and molybdenum both tend to be susceptible to hydrogen peroxide induced corrosion. Advanced node devices are generally highly susceptible to corrosion issues owing to the extremely small feature size of the metal structures. Moreover, galvanic coupling can further accelerate corrosion in bimetallic applications. For example, the corrosion of a molybdenum liner may be accelerated via the coupling with the tungsten plug or interconnect. There is a need for CMP compositions that can polish both tungsten and molybdenum layers and provide improved inhibition of molybdenum corrosion, particularly for bimetallic CMP applications.

### BRIEF SUMMARY OF THE INVENTION

A chemical mechanical polishing composition is disclosed. The composition comprises, consists of, or consists essentially of a liquid carrier, abrasive particles dispersed in the liquid carrier, an iron-containing accelerator, a stabilizer bound to the iron-containing accelerator, at least one inhibitor of tungsten etching, the inhibitor of tungsten etching including at least one nitrogen containing group, and a substituted piperazine compound.

### DETAILED DESCRIPTION OF THE INVENTION

Chemical mechanical polishing compositions and methods for using those compositions to polish a substrate are disclosed. In one example embodiment, a chemical mechanical polishing composition comprises, consists essentially of, or consists of an aqueous based liquid carrier, abrasive particles dispersed in the liquid carrier, an iron-containing accelerator, a stabilizer bound to the iron-containing accelerator, at least one inhibitor of tungsten etching, the inhibitor of tungsten etching including at least one nitrogen containing group, and a substituted piperazine compound. A method for polishing a molybdenum containing substrate includes contacting the substrate with one of the disclosed polishing compositions, moving the polishing composition relative to the substrate, and abrading the substrate to remove molybdenum from the substrate and thereby polish the substrate.

The disclosed polishing compositions and corresponding (CMP methods) may confer significant advantages. In example embodiments, disclosed polishing compositions may advantageously polish both tungsten and molybdenum at high rates while suppressing both tungsten and molybdenum corrosion.

The polishing composition contains abrasive particles suspended (or dispersed) in a liquid carrier. The liquid carrier is used to facilitate the application of the abrasive particles and chemical additives to the surface of the substrate to be polished (e.g., planarized). The liquid carrier may be any suitable carrier (e.g., a solvent) including lower alcohols (e.g., methanol, ethanol, etc.), ethers (e.g., dioxane, tetrahydrofuran, etc.), water, and mixtures thereof. Preferably, the liquid carrier comprises, consists essentially of, or consists of water, more preferably deionized water.

The abrasive particles may include substantially any suitable abrasive particles such as metal oxide particles, diamond particles, and/or ceramic particles. Metal oxide particles are generally preferred and may include, for example, silica and/or alumina abrasive particles including colloidal and/or fumed metal oxide particles. Ceramic particles may include materials such as cubic boron nitride or silicon carbide.

As used herein the term colloidal particles (such as colloidal silica particles) refers to particles that are prepared via a wet process rather than a pyrogenic or flame hydrolysis process which produces structurally different particles. The disclosed embodiments may include aggregated or non-aggregated colloidal particles (e.g., colloidal silica particles). Non-aggregated particles are individually discrete particles that may be spherical or nearly spherical in shape, but can have other shapes as well (such as generally elliptical, square, or rectangular cross-sections). Aggregated particles are particles in which multiple discrete primary particles are clustered or bonded together to form aggregates having generally irregular shapes.

The abrasive particles may have substantially any suitable particle size. The particle size of a particle suspended in a liquid carrier may be defined in the industry using various means. For example, the particle size may be defined as the diameter of the smallest sphere that encompasses the particle and may be measured using a number of commercially available instruments, for example, including the CPS Disc Centrifuge, Model DC24000HR (available from CPS Instruments, Prairieville, Louisiana) or the Zetasizer® available from Malvern Instruments®. The abrasive particles may have an average particle size of about 5 nm or more (e.g., about 10 nm or more, about 20 nm or more, about 30 nm or more, about 40 nm or more, or about 50 nm or more). The abrasive particles may have an average particle size of about 300 nm or less (e.g., about 250 nm or less, about 200 nm or less, about 180 nm or less, or about 150 nm or less). Accordingly, the abrasive particles may have an average particle size in a range bounded by any two of the above endpoints. For example, the abrasive particles may have an average particle size in a range from about 5 nm to about 300 nm (e.g., from about 10 nm to about 200 nm, from about 20 nm to about 200 nm, or from about 50 nm to about 150 nm).

The polishing composition may include substantially any suitable amount of the abrasive particles. If the polishing composition comprises too little abrasive, the composition may not exhibit a sufficient removal rate. In contrast, if the polishing composition comprises too much abrasive, then the polishing composition may exhibit undesirable polishing performance and/or may not be cost effective. Polishing composition configured for bulk removal operations (e.g., bulk tungsten and/or bulk molybdenum) generally relatively small amounts of the abrasive particles, for example, about 0.01 wt. % or more at point of use (e.g., about 0.02 wt. % or more, about 0.05 wt. % or more, about 0.1 wt. % or more, or about 0.15 wt. % or more). The concentration of abrasive particles in the polishing composition is generally less than about 10 wt. % at point of use (e.g., about 5 wt. % or less, about 3 wt. % or less, about 2 wt. % or less, or about 1.5 wt. % or less, or about 1 wt. % or less). Accordingly, the concentration of abrasive particles in the polishing composition may be bounded by any two of the aforementioned endpoints. For example, the polishing composition may include from about 0.01 wt. % to about 10 wt. % of the abrasive particles at point of use (e.g., from about 0.02 wt. % to about 2 wt. %, from about 0.05 wt. % to about 1 wt. %, or from about 0.1 wt. % to about 1 wt. %).

In certain advantageous embodiments, the abrasive particles may include cationic (positively charged) abrasive particles. Preferred cationic abrasive particles include cationic colloidal silica particles. The cationic colloidal silica particles may have a permanent positive charge or a non-permanent positive charge. For example, the cationic colloidal silica particles may have a permanent positive charge. By permanent positive charge it is meant that the positive charge on the silica particles is not readily reversible, for example, via flushing, dilution, filtration, and the like. A permanent positive charge may be the result, for example, of covalently bonding a cationic compound with the colloidal silica. A permanent positive charge is in contrast to a reversible positive charge that may be the result, for example, of an electrostatic interaction between a cationic compound and the colloidal silica.

Cationic colloidal silica particles having a permanent positive charge may be prepared via treating the colloidal silica particles silica particles with an aminosilane compound as disclosed in commonly assigned U.S. Pat. Nos. 7,994,057 and 9,028,572 or in U.S. Pat. No. 9,382,450. Example cationic colloidal silica particles may be treated using any suitable treating method to obtain the permanently charged particles. For example, a quaternary aminosilane compound and the colloidal silica may be added simultaneously to some or all of the other components in the polishing composition. Alternatively, the colloidal silica particles may be treated with a quaternary aminosilane compound (e.g., via a heating a mixture of the colloidal silica and the aminosilane) prior to mixing with the other components of the polishing composition. Colloidal silica particles having a permanent positive charge may also be obtained by incorporating a chemical species, such as an aminosilane compound, in the colloidal silica particles as disclosed in in commonly assigned U.S. Pat. No. 9,422,456.

Cationic colloidal silica particles having a non-permanent positive charge may be prepared via introducing a cationic surfactant into the polishing composition, for example, as disclosed commonly assigned U.S. Pat. No. 9,631,122. Such cationic surfactants may include, for example, one or a combination of tetrabutylammonium, tetrapentylammonium, tetrabutylphosphonium, tributylmethylphosphonium, tributyloctylphosphonium, and benzyltributylammonium.

In advantageous embodiments, cationic colloidal silica particles have a zeta potential of about 10 mV or more (e.g., about 15 mV or more, about 20 mV or more, about 25 mV or more, or about 30 mV or more) in the polishing composition (e.g., in a pH range from about 1 to about 4 and in the presence of the various chemical additives disclosed below). The cationic colloidal silica particles may also have a zeta potential of about 60 mV or less (e.g., about 55 mV or less or about 50 mV or less) in the polishing composition. For example, the cationic colloidal silica particles may have a zeta potential in a range from about 10 mV to about 60 mV (e.g., about 20 mV to about 60 mV, or about 25 mV to about 50 mV) in the polishing composition. It will be appreciated that the zeta potential of a particle refers to the electrical potential difference between the electrical charge of the ions surrounding the particle and the electrical charge of the bulk solution of the polishing composition (e.g., the liquid carrier and any other components dissolved therein) and that the zeta potential generally depends on the pH and ionic strength (e.g., as indicated via a conductivity measurement) of the aqueous medium. The zeta potential of a dispersion such as a polishing composition may be measured using commercially available instrumentation such as the Zetasizer available from Malvern Instruments, the ZetaPlus Zeta Potential Analyzer available from Brookhaven Instruments, and/or an electro-acoustic spectrometer available from Dispersion Technologies, Inc.

In other embodiments, the abrasive particles may include anionic (negatively charged) particles. Anionic particles may include substantially any suitable anionic particles, for example including anionic silica particles and/or anionic alumina particles. Anionic silica particles may include, for example, anionic colloidal silica particles while anionic alumina particles may include, for example, anionic alpha alumina particles.

Silica particles may be anionic in their natural state at the pH of the polishing composition (for certain compositions). Alumina tends to be cationic in acidic compositions. In preferred embodiments, the anionic particles (e.g., the anionic silica particles or the anionic alumina particles) may be rendered anionic at the pH of the polishing composition via surface metal doping and/or chemical surface treatment (or partial surface treatment), for example, with an organic acid, a sulfur-based acid, a phosphorus-based acid, and/or an anionic polymer. Example treatment methodologies are disclosed in U.S. Pat. No. 9,382,450.

In advantageous embodiments, anionic particles have a negative zeta potential of about 10 mV or more (e.g., about 15 mV or more, about 20 mV or more, or about 25 mV or more) in the polishing composition. The anionic particles may further have a negative zeta potential of about 50 mV or less in the polishing composition. For example, the anionic particles may have a zeta potential in a range from about negative 10 to about negative 50 mV (e.g., from about negative 15 to about negative 50 mV, from about negative 20 to about negative 50, or from about negative 25 to about negative 50).

In example embodiments in which the abrasive particles include anionic particles, the polishing composition generally further includes at least one anionic polymer. Suitable anionic polymers may be homopolymers or copolymers and may include monomer units selected, for example, from carboxylic acid groups, sulfonic acid groups, and phosphonic acid groups. For example suitable anionic polymers may include poly(acrylic acid) (PAA), poly(methacrylic acid) (PMAA), poly(maleic acid) (PMA), poly(vinyl sulfonic acid) (PVSA), poly(styrene sulfonic acid), poly(2-acrylamido-2-methylpropane sulfonic acid), poly(styrenesulfonic acid-co-maleic acid), and combinations thereof. Preferred anionic polymers include poly(vinyl sulfonic acid) (PVSA), poly(styrene sulfonic acid) (PSSA), and mixtures thereof.

The polishing composition is generally acidic having a pH of less than about 6. The polishing composition may have a pH of about 1 or more (e.g., about 1.5 or more or about 2 or more). Moreover, the polishing composition may have a pH of about 5 or less (e.g., about 4.5 or less, about 4 or less, about 3.5 or less, or about 3 or less). According, the polishing composition may have a pH in a range bounded by any two of the aforementioned endpoints, for example, in a range from about 1 to about 6 (e.g., from about 1.5 to about 5, from about 1.5 to about 4, from about 2 to about 3.5, or from about 2 to about 3).

The pH of the polishing composition may be achieved and/or maintained by any suitable means. The polishing composition may include substantially any suitable pH adjusting agents or buffering systems. For example, suitable pH adjusting agents may include nitric acid, sulfuric acid, phosphoric acid, phthalic acid, citric acid, adipic acid, oxalic acid, malonic acid, maleic acid, ammonium hydroxide, and the like while suitable buffering agents may include phosphates, sulfates, acetates, malonates, oxalates, borates, ammonium salts, and the like.

The disclosed polishing composition may include an iron-containing polishing rate accelerator (e.g., a tungsten or molybdenum rate accelerator). An iron-containing accelerator as used herein is an iron-containing chemical compound that may increase the removal rate of tungsten or molybdenum during a metal CMP operation. For example, the iron-containing accelerator may include a soluble iron-containing catalyst such as is disclosed in U.S. Pat. Nos. 5,958,288 and 5,980,775. Such an iron-containing catalyst may be soluble in the liquid carrier and may include, for example, ferric (iron III) or ferrous (iron II) compounds such as iron nitrate, iron sulfate, iron halides, including fluorides, chlorides, bromides, and iodides, as well as perchlorates, perbromates and periodates, and organic iron compounds such as iron acetates, carboxylic acids, acetylacetonates, citrates, gluconates, malonates, oxalates, phthalates, and succinates, and mixtures thereof.

An iron-containing accelerator may also include an iron-containing activator (e.g., a free radical producing compound) or an iron-containing catalyst associated with (e.g., coated or bonded to) the surface of the colloidal silica particle such as is disclosed in U.S. Pat. Nos. 7,029,508 and 7,077,880. For example, the iron-containing accelerator may be bonded with the silanol groups on the surface of the colloidal surface particles.

The amount of iron-containing accelerator in the polishing composition may be varied depending upon the oxidizing agent used and the chemical form of the accelerator. When the oxidizing agent is hydrogen peroxide (or one of its analogs) and a soluble iron-containing catalyst is used (such as ferric nitrate or hydrates of ferric nitrate), the catalyst may be present in the composition at point of use in an amount sufficient to provide a range from about 0.5 to about 3000 ppm Fe based on the total weight of the composition. For example, polishing compositions configured for bulk tungsten or molybdenum removal may include about 1 ppm Fe or more at point of use (e.g., about 5 ppm or more, about 10 ppm or more, or about 15 ppm or more). The polishing composition may include about 500 ppm Fe or less at point of use (e.g., about 200 ppm or less, about 100 ppm or less, or about 50 ppm or less). Accordingly, the point of use polishing composition may include Fe in a range bounded by any one of the above endpoints (e.g., from about 1 ppm to about 500 ppm, from about 5 ppm to about 200 ppm, from about 10 ppm to about 100 ppm, or from about 15 ppm to about 50 ppm). For tungsten or molybdenum buff applications that do not require high metal removal rates, the catalyst may be present in lower amounts, for example, from about 0.1 ppm to about 50 ppm Fe (e.g., from about 0.2 ppm to about 20 ppm or from about 0.2 to about 10 ppm) at point of use.

Embodiments of the polishing composition including an iron-containing accelerator may further include a stabilizer. Without such a stabilizer, the iron-containing accelerator and the oxidizing agent, if present, may react in a manner that degrades the oxidizing agent rapidly over time. The addition of a stabilizer tends to reduce the effectiveness of the iron-containing accelerator such that the choice of the type and amount of stabilizer added to the polishing composition may have a significant impact on CMP performance. The addition of a stabilizer may lead to the formation of a stabilizer/accelerator complex that inhibits the accelerator from reacting with the oxidizing agent, if present, while at the same time allowing the accelerator to remain sufficiently active so as to promote rapid tungsten or molybdenum polishing rates.

Useful stabilizers include phosphoric acid, organic acids such as dicarboxylic acids, phosphonate compounds, nitriles, and other ligands which bind to the metal and reduce its reactivity toward hydrogen peroxide decomposition and mixture thereof. The acid stabilizers may be used in their conjugate form, e.g., the carboxylate can be used instead of the carboxylic acid. The term “acid” as it is used herein to describe useful stabilizers also means the conjugate base of the acid stabilizer. Stabilizers can be used alone or in combination and significantly reduce the rate at which oxidizing agents such as hydrogen peroxide decompose.

Preferred stabilizers include phosphoric acid, acetic acid, phthalic acid, citric acid, adipic acid, oxalic acid, malonic acid, aspartic acid, succinic acid, glutaric acid, pimelic acid, suberic acid, azelaic acid, sebacic acid, maleic acid, glutaconic acid, muconic acid, ethylenediaminetetraacetic acid (EDTA), propylenediaminetetraacetic acid (PDTA), and mixtures thereof. The preferred stabilizers may be added to the compositions of this invention in an amount ranging from about 1 equivalent per iron-containing accelerator to about 3.0 weight percent or more (e.g., from about 1 equivalent to about 5 equivalents, or from about 3 equivalents to about 10 equivalents). As used herein, the term “equivalent per iron-containing accelerator” means one molecule of stabilizer per iron ion in the composition. For example, two equivalents per iron-containing accelerator means two molecules of stabilizer for each catalyst ion.

The polishing composition may optionally further include an oxidizing agent. The oxidizing agent may be added to the polishing composition during the slurry manufacturing process or just prior to the CMP operation (e.g., in a tank located at the semiconductor fabrication facility). Preferred oxidizing agents include inorganic or organic per-compounds. A per-compound as defined herein is a compound containing at least one peroxy group (—O—O—) or a compound containing an element in its highest oxidation state. Examples of compounds containing at least one peroxy group include but are not limited to hydrogen peroxide and its adducts such as urea hydrogen peroxide and percarbonates, organic peroxides such as benzoyl peroxide, peracetic acid, and di-t-butyl peroxide, monopersulfates (SO₅^{═}), dipersulfates (S₂O₈^{═}), and sodium peroxide. Examples of compounds containing an element in its highest oxidation state include but are not limited to periodic acid, periodate salts, perbromic acid, perbromate salts, perchloric acid, perchlorate salts, perboric acid, and perborate salts and permanganates. The most preferred oxidizing agent is hydrogen peroxide.

The oxidizing agent may be present in the polishing composition in substantially any suitable amount, for example, from about 0.0 wt. % to about 20 wt. % at point of use. In example embodiments configured for bulk tungsten or molybdenum removal that include a hydrogen peroxide oxidizer and a soluble iron-containing catalyst, the oxidizer may be present in the polishing composition in an amount ranging from about 0.1 wt. % to about 10 wt. % at point of use (e.g., from about 0.5 wt. % to about 5 wt. % or from about 1 wt. % to about 4 wt. %). In example embodiments configured for buff tungsten or molybdenum applications, the amount of hydrogen peroxide in the composition is generally less, for example, from about 0 wt. % to about 1 wt. %.

The polishing composition further includes at least one metal etch inhibitor and/or topography control agent. Suitable inhibitor compounds may inhibit the conversion of solid tungsten or molybdenum into soluble compounds while at the same time allowing for effective removal of the metal via the CMP operation. The polishing composition may include substantially any suitable inhibitor, for example, inhibitor compounds disclosed in commonly assigned U.S. Pat. Nos. 9,238,754; 9,303,188; and 9,303,189.

Example classes of compounds that that may be useful etch inhibitors include compounds having nitrogen containing functional groups such as nitrogen containing heterocycles, alkyl ammonium ions, amino alkyls, and amino acids. Useful amino alkyl corrosion inhibitors include, for example, hexylamine, tetramethyl-p-phenylene diamine, octylamine, diethylene triamine, dibutyl benzylamine, aminopropylsilanol, aminopropylsiloxane, dodecylamine, mixtures thereof, and synthetic and naturally occurring amino acids including, for example, lysine, tyrosine, glutamine, glutamic acid, arginine, histidine, aspartic acid, cystine, and glycine (aminoacetic acid).

Suitable compounds may alternatively and/or additionally include an amine compound in solution in the liquid carrier. The amine compound (or compounds) may include a primary amine, a secondary amine, a tertiary amine, or a quaternary amine. The amine compound may further include a monoamine, a diamine, a triamine, a tetramine, or an amine based polymer having a large number of repeating amine groups (e.g., 4 or more amine groups).

Suitable compounds may alternatively and/or additionally be a cationic surfactant. The use of a cationic surfactant may advantageously reduce the metal etch rate and improve planarity (e.g., reducing dishing and/or erosion). In certain embodiments, the polishing compound may include a nitrogen containing cationic surfactant, such as a quaternary amine compound or a polyquaternary amine compound. By polyquaternary amine it is meant that the compound includes from 2 to 4 quaternary ammonium groups such that the polyquaternary amine is a diquaternary amine compound, a triquaternary amine compound, or a tetraquaternary amine compound. Diquaternary amine compounds may include, for example, N,N′-methylenebis(dimethylteradecylammonium bromide), N,N,N′,N′,N′-pentamethyl-N-tallow-1,3-propane-diammonium dichloride, N,N′-hexamethylenebis(tributylammonium hydroxide), decamethonium bromide, didodecyl-tetramethyl-1,4-butanediaminium diiodide, 1,5-dimethyl-1,5-diazoniabicyclo(3.2.2)nonane dibromide, dimethylcocoamine bis(chloroethyl) ether diquaternary ammonium salt, and the like. Triquaternary amine compounds may include, for example, N(1),N(6)-didoecyl-N(1),N(1),N(6),N(6)-tetramethyl-1,6-hexanediaminium diiodide. Tetraquaternary amine compounds may include, for example, methanetetrayltetrakis(tetramethylammonium bromide). The polyquaternary amine compound may further include a long chain alkyl group (e.g., having 10 or more carbon atoms), For example, a polyquaternary amine compound having a long chain alkyl group may include N,N′-methylenebis(dimethyltetradecylammonium bromide), N,N,N′,N′,N′-pentamethyl-N-tallow-1,3-propane-diammonium dichloride, didodecyl-tetramethyl-1,4-butanediaminium di iodide, and N(1),N(6)-didodecyl-N(1),N(1),N(6),N(6)-tetramethyl-1,6-hexanediaminium diiodide.

Suitable compounds may alternatively and/or additionally include a cationic polymer. Example cationic polymers include but are not limited to poly(vinylimidazolium), poly(methacryloyloxyethyltrimethylammonium) chloride (polyMADQUAT), poly(diallyldimethylammonium) chloride (polyDADMAC) (i.e., Polyquaternium-6), poly(dimethylamine-co-epichlorohydrin), poly[bis(2-chloroethyl) ether-alt-1,3-bis[3-(dimethylamino)propyl]urea](i.e., Polyquaternium-2), copolymers of hydroxyethyl cellulose and diallyldimethylammonium (i.e., Polyquaternium-4), copolymers of acrylamide and diallyldimethylammonium (i.e., Polyquaternium-7), quaternized hydroxyethylcellulose ethoxylate (i.e., Polyquaternium-10), copolymers of vinylpyrrolidone and quaternized dimethylaminoethyl methacrylate (i.e., Polyquaternium-11), copolymers of vinylpyrrolidone and quaternized vinylimidazole (i.e., Polyquaternium-16), Polyquaternium-24, a terpolymer of vinylcaprolactam, vinylpyrrolidone, and quaternized vinylimidazole (i.e., Polyquaternium-46), 3-Methyl-1-vinylimidazolium methyl sulfate-N-vinylpyrrolidone copolymer (i.e., Polyquaternium-44), and copolymers of vinylpyrrolidone and diallyldimethylammonium. Additionally, suitable cationic polymers include cationic polymers for personal care such as Luviquat® Supreme, Luviquat® Hold, Luviquat® UltraCare, Luviquat® FC 370, Luviquat® FC 550, Luviquat® FC 552, Luviquat® Excellence, GOHSEFIMER K210™, GOHSENX K-434, and combinations thereof.

Cationic polymers may also include an amino acid monomer (such compounds may also be referred to as polyamino acid compounds). Suitable polyamino acid compounds may include substantially any suitable amino acid monomer groups, for example, including polyarginine, polyhistidine, polyalanine, polyglycine, polytyrosine, polyproline, and polylysine. In example embodiments, polylysine may be a preferred polyamino acid. It will be understood that polylysine may include ε-polylysine and/or α-polylysine composed of D-lysine and/or L-lysine. The polylysine may thus include α-poly-L-lysine, α-poly-D-lysine, ε-poly-L-lysine, ε-poly-D-lysine, and mixtures thereof. The most preferred polylysine is ε-poly-L-lysine. It will further be understood that the polyamino acid compound (or compounds) may be used in any accessible form, e.g., the conjugate acid or base and salt forms of the polyamino acid may be used instead of (or in addition to) the polyamino acid.

In certain advantageous embodiments, the polishing composition may include first and second distinct inhibitor compounds. For example, the first inhibitor compound in the composition may include a cationic polymer such as a polyamino acid (with polylysine being preferred) and the second inhibitor compound in the composition may include an amino acid (with glycine, arginine, and a histidine being preferred).

The disclosed polishing compositions further include a supplemental molybdenum etch (corrosion) inhibitor. It will be appreciated that molybdenum metal is particularly susceptible to corrosion (especially in the presence of hydrogen peroxide). One aspect of the disclosed embodiments was the realization that this susceptibility can be magnified in bimetallic applications in which molybdenum and tungsten metals are in contact with one another and that further molybdenum inhibition may be required. However, it was also realized that increasing the inhibitor strength of the polishing composition can (and often does) have a severe negative impact on tungsten polishing rates. This negative impact is unacceptable for bulk polishing operations in which high removal rates and throughputs are required. In the disclosed polishing compositions, the use of one or more tungsten etch inhibitors and a supplemental molybdenum etch inhibitor has been advantageously found to further (and significantly) suppress molybdenum corrosion without significantly impacting the molybdenum or tungsten polishing rates. The disclosed polishing compositions including one or more tungsten etch inhibitors and the supplemental molybdenum etch inhibitor may therefore be particularly advantageous in bimetallic polishing operations in which molybdenum and tungsten metals contact one another in the substrate to be polished.

In preferred embodiments, the supplemental molybdenum etch inhibitor comprises a substituted piperazine compound. A substituted piperazine compound is an organic compound including a six-membered ring containing opposing nitrogen atoms as given in the following formula:

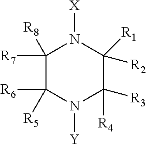

where R₁, R₂, R₃, R₄, R₅, R₆, R₇, and R₈ may be substantially any small, non-carbonyl group (by small it is meant having 10 or less carbon atoms). R₁-R₈ are preferably hydrogen. By substituted it is meant that at least one of X and Y is an alkyl amine group. In preferred embodiments, one of X and Y is hydrogen and the other one of X and Y is a straight-chain, alkyl amine having 1, 2, or 3 carbon atoms (including methylamine, ethylamine, or propylamine). In other preferred embodiments, both X and Y may be a straight-chain, alkyl amine group having 1, 2, or 3 carbon atoms. In such embodiments, X and Y may be the same or different alkyl amines. The most preferred supplemental molybdenum etch inhibitors include aminoethyl piperazine (in which R₁-R₈ and X is hydrogen and Y is ethylamine) and 1,4-Bis(3-aminopropyl)piperazine (in which R₁-R₈ is hydrogen and both X and Y are propylamine).

The disclosed embodiments may include substantially any suitable amount of the supplemental molybdenum inhibitor. In general, a sufficient amount of the inhibitor is required to inhibit the molybdenum etch rate without significantly degrading the tungsten or molybdenum polishing rates. When the supplemental molybdenum etch inhibitor is a substituted piperazine compound, the polishing composition may include about 0.1 ppm by weight or more at point of use (e.g., about 0.5 ppm or more, about 1 ppm or more, or about 2 ppm or more) of the substituted piperazine compound. Moreover, the polishing composition may include about 50 ppm by weight or less at point of use (e.g., about 20 ppm or less, about 10 ppm or less, or about 5 ppm or less) of the substituted piperazine compound. Accordingly, the polishing composition may include a concentration of the substituted piperazine compound bounded by any two of the above endpoints. For example, the polishing composition may include from about 0.1 to about 50 ppm by weight (e.g., from about 0.5 ppm to about 20 ppm, from about 1 ppm to about 10 ppm, or from about 2 ppm to about 5 ppm) of the substituted piperazine compound.

The disclosed polishing compositions may include substantially any additional optional chemical additives. For example, the disclosed compositions may include dispersants and biocides. Such additional additives are purely optional. The disclosed embodiments are not so limited and do not require the use of any one or more of such additives. In embodiments further including a biocide, the biocide may include any suitable biocide, for example an isothiazolinone biocide known to those of ordinary skill in the art.

The polishing composition may be prepared using any suitable techniques, many of which are known to those skilled in the art. The polishing composition may be prepared in a batch or continuous process. Generally, the polishing composition may be prepared by combining the components thereof in any order. The term “component” as used herein includes the individual ingredients (e.g., the colloidal silica, the iron-containing accelerator, the amine compound, etc.).

For example, the polishing composition components (such as the iron-containing accelerator, the stabilizer, the tungsten etch inhibitor(s), the supplemental molybdenum inhibitor, and/or the biocide) may be added directly to an abrasive dispersion (such as an anionic or cationic colloidal silica dispersion). The silica dispersion and the other components may be blended together using any suitable techniques for achieving adequate mixing. Such blending/mixing techniques are well known to those of ordinary skill in the art. The oxidizing agent, when present, may be added at any time during the preparation of the polishing composition. For example, the polishing composition may be prepared prior to use, with one or more components, such as the oxidizing agent, being added just prior to the CMP operation (e.g., within about 1 minute, or within about 10 minutes, or within about 1 hour, or within about 1 day, or within about 1 week of the CMP operation). The polishing composition also may also be prepared by mixing the components at the surface of the substrate (e.g., on the polishing pad) during the CMP operation.

The polishing composition may advantageously be supplied as a one-package system comprising the abrasive particles, the iron-containing accelerator, the stabilizer, the tungsten etch inhibitor(s), the supplemental molybdenum inhibitor, and other optional components. Hydrogen peroxide may be desirably supplied separately from the other components of the polishing composition and may be combined, e.g., by the end-user, with the other components of the polishing composition shortly before use (e.g., 1 week or less prior to use, 1 day or less prior to use, 1 hour or less prior to use, 10 minutes or less prior to use, or 1 minute or less prior to use). Various other two-container, or three- or more-container, combinations of the components of the polishing composition are within the knowledge of one of ordinary skill in the art.

The polishing composition of the invention may also be provided as a concentrate which is intended to be diluted with an appropriate amount of water prior to use. In such an embodiment, the polishing composition concentrate may include the abrasive particles, the iron-containing accelerator, the stabilizer, the tungsten etch inhibitor(s), the supplemental molybdenum inhibitor, and other optional components in amounts such that, upon dilution of the concentrate with an appropriate amount of water, and an optional oxidizing agent if not already present in an appropriate amount, each component of the polishing composition will be present in the polishing composition in an amount within the appropriate ranges recited above for each component. For example, the colloidal silica and other optional components may each be present in the polishing composition in an amount that is about 2 times (e.g., about 3 times, about 4 times, about 5 times, or even about 10 times) greater than the point of use concentrations recited above for each component so that, when the concentrate is diluted with an equal volume of (e.g., 2 equal volumes of water, 3 equal volumes of water, 4 equal volumes of water, or even 9 equal volumes of water respectively), along with the oxidizing agent in a suitable amount, each component will be present in the polishing composition in an amount within the ranges set forth above for each component. Furthermore, as will be understood by those of ordinary skill in the art, the concentrate may contain an appropriate fraction of the water present in the final polishing composition in order to ensure that other components are at least partially or fully dissolved in the concentrate.

The disclosed polishing compositions may be advantageously used to polish a substrate including a tungsten layer and/or a molybdenum layer as well as a dielectric material such as silicon oxide and/or silicon nitride. In some applications, the tungsten and molybdenum layers may contact one another, for example, a molybdenum layer may be used as a liner for tungsten plugs and/or interconnects. The disclosed embodiments may be particularly advantageous for such bimetallic applications.

The polishing method of the invention is particularly suited for use in conjunction with a chemical mechanical polishing (CMP) apparatus. Typically, the apparatus includes a platen, which, when in use, is in motion and has a velocity that results from orbital, linear, or circular motion, a polishing pad in contact with the platen and moving with the platen when in motion, and a carrier that holds a substrate to be polished by contacting and moving relative to the surface of the polishing pad. The polishing of the substrate takes place by the substrate being placed in contact with the polishing pad and the polishing composition of the invention and then the polishing pad moving relative to the substrate, so as to abrade at least a portion of the substrate (such as the tungsten and molybdenum layers described above) to polish the substrate.

A substrate may be planarized or polished with the chemical mechanical polishing composition with any suitable polishing pad (e.g., polishing surface). Suitable polishing pads include, for example, woven and non-woven polishing pads. Moreover, suitable polishing pads can comprise any suitable polymer of varying density, hardness, thickness, compressibility, ability to rebound upon compression, and compression modulus. Suitable polymers include, for example, polyvinylchloride, polyvinylfluoride, nylon, fluorocarbon, polycarbonate, polyester, polyacrylate, polyether, polyethylene, polyamide, polyurethane, polystyrene, polypropylene, coformed products thereof, and mixtures thereof.

The following examples further illustrate the invention but, of course, should not be construed as in any way limiting its scope.

### Example 1

Eleven polishing compositions were prepared. This example demonstrates the effectiveness of the supplemental molybdenum etch inhibitor at reducing the static etch rate of molybdenum. Each composition included 445 ppm by weight malonic acid, 206 ppm by weight ferric nitrate nonahydrate (Fe(NO₃)₃·9H₂O), 4 ppm by weight epsilon poly-L-lysine, 20 ppm by weight L-histidine, 1.0 weight percent hydrogen peroxide, 16 ppm by weight Proxel AQ preservative, and 0.12 weight percent of a cationic colloidal silica that was treated with an amino silane compound. Each of compositions 1B-1K further included aminoethyl piperazine (AEP) in the amounts given in Table 1A. The pH of each composition was adjusted to 2.15 using nitric acid or potassium hydroxide but was observed to drift slightly upward. The final pH values are also given in Table 1A. The conductivity, particle size, and zeta potential of each composition was also measured and are reported in Table 1A. The particle size and zeta potential measurements were made using a Zetasizer® (Malvern Instruments).

The static etch rates of tungsten and molybdenum were measured for each of the above compositions. The static etch rate of tungsten was measured by immersing one inch square wafer samples (cleaved from 8 inch diameter blanket wafers having an initial W thickness of 8 kÅ) in the respective compositions (tungsten side up) for 5 minutes at 45 degrees C. The static etch rate of molybdenum was measured using two different molybdenum samples: (i) one inch square wafer samples cleaved from 12 inch diameter blanket wafers having an initial Mo thickness of 4 kÅ and (ii) one inch square wafer samples cleaved from 12 inch diameter blanket wafers having an initial Mo thickness of 2 kÅ. The molybdenum samples were immersed in the respective compositions (molybdenum side up) for 1 minute (first samples) or 30 seconds (second samples) at 25 degrees C. The SER values are reported in Table 1B. Each SER value is the average of two measurements.

TABLE 1B

| | | | | Particle | Zeta |
|---|---|---|---|---|---|
| Polishing | AEP | Final | Conductivity | Size | Potential |
| Composition | (ppm) | pH | (μS/cm) | (nm) | (mV) |
| 1A | 0 | 2.65 | 1093 | 105 | 37 |
| 1B | 1 | 2.66 | 1092 | 102 | 39 |
| 1C | 2 | 2.65 | 1089 | 104 | 40 |
| 1D | 3 | 2.65 | 1084 | 104 | 40 |
| 1E | 4 | 2.65 | 1084 | 105 | 40 |
| 1F | 5 | 2.66 | 1078 | 104 | 38 |
| 1G | 6 | 2.66 | 1077 | 104 | 40 |
| 1H | 8 | 2.66 | 1070 | 103 | 40 |
| 1I | 10 | 2.67 | 1063 | 105 | 39 |
| 1J | 12 | 2.67 | 1059 | 102 | 39 |
| 1K | 16 | 2.69 | 1048 | 102 | 39 |

TABLE 1B

| Polishing | AEP | W SER Rate | Mo1 SER Rate | Mo2 SER Rate |
|---|---|---|---|---|
| Composition | (ppm) | (Å/min) | (Å/min) | (Å/min) |
| 1A | 0 | 56 | 2259 | 1119 |
| 1B | 1 | 70 | 1869 | 912 |
| 1C | 2 | 73 | 884 | 516 |
| 1D | 3 | 71 | 529 | 417 |
| 1E | 4 | 72 | 482 | 363 |
| 1F | 5 | 69 | 494 | 353 |
| 1G | 6 | 68 | 433 | 296 |
| 1H | 8 | 66 | 298 | 260 |
| 1I | 10 | 63 | 280 | 262 |
| 1J | 12 | 60 | 329 | 247 |
| 1K | 16 | 57 | 204 | 181 |

As is evident from the data set forth in Tables 1A and 1B, the supplemental molybdenum etch inhibitor significantly reduces the etch rate of molybdenum while leaving the etch rate of tungsten essentially unchanged. In particular, up to a 10× reduction in the molybdenum etch rate was observed without impacting the conductivity, particle size, or zeta potential of the compositions.

### Example 2

Fourteen polishing compositions were prepared. This example demonstrates that small additions of an aminoethyl piperazine supplemental molybdenum etch inhibitor do not significantly impact the polishing performance of the composition (while providing a significant reduction in the molybdenum etch rate). Each of the polishing compositions included an amino-silane treated, cationic colloidal silica having an average particle size of about 100 nm, 445 ppm by weight malonic acid, 206 ppm by weight ferric nitrate nonahydrate (Fe(NO₃)₃·9H₂O), 4 ppm by weight epsilon poly-L-lysine, 20 ppm by weight L-histidine, 16 ppm by weight Proxel AQ preservative, and 1.0 wt. % hydrogen peroxide. The pH of each composition was adjusted to 2.15 using nitric acid or potassium hydroxide, which resulted in a pH value of 2.7 at point of use (POU). Polishing compositions 2D-2N further included aminoethyl piperazine. The amounts of the cationic colloidal silica and the aminoethyl piperazine (AEP) are listed in Table 2A.

The CMP performance of polishing compositions 2A-2N was evaluated using a Reflexion® CMP polishing tool (Applied Materials) with an VP6000 polishing pad (DuPont) and in-situ conditioning using a Saesol AK45 conditioner at 4 lbs. Tungsten, molybdenum, TEOS, and SiN polishing rates were obtained by polishing corresponding 300 mm blanket wafers at a downforce of 1.0 psi, a platen speed of 83 rpm, a head speed of 73 rpm, and a slurry flow rate was 250 mL/min. Blanket wafer polishing rates (removal rates) are shown in Table 2B.

TABLE 2A

| Polishing | Colloidal Silica | AEP |
|---|---|---|
| Composition | (wt. %) | (ppm) |
| 2A | 0.12 | 0 |
| 2B | 0.08 | 0 |
| 2C | 0.06 | 0 |
| 2D | 0.12 | 1 |
| 2E | 0.08 | 1 |
| 2F | 0.17 | 2 |
| 2G | 0.1 | 2 |
| 2H | 0.14 | 3 |
| 2I | 0.06 | 3 |
| 2J | 0.17 | 4 |
| 2K | 0.1 | 4 |
| 2L | 0.12 | 6 |
| 2M | 0.08 | 6 |
| 2N | 0.12 | 12 |

TABLE 2B

| Polishing | W RR | Mo RR | TEOS RR | SIN RR |
|---|---|---|---|---|
| Composition | (Å/min) | (Å/min) | (Å/min) | (Å/min) |
| 2A | 991 | 660 | 9 | 6 |
| 2B | 877 | 629 | 6 | 5 |
| 2C | 794 | 580 | 6 | 4 |
| 2D | 897 | 613 | 9 | 6 |
| 2E | 814 | 689 | 6 | 4 |
| 2F | 813 | 726 | 11 | 6 |
| 2G | 723 | 553 | 8 | 4 |
| 2H | 611 | 491 | 10 | 5 |
| 2I | 614 | 586 | 5 | 4 |
| 2J | 692 | 572 | 10 | 6 |
| 2K | 645 | 701 | 6 | 3 |
| 2L | 601 | 544 | 8 | 6 |
| 2M | 585 | 535 | 7 | 4 |
| 2N | 524 | 485 | 9 | 6 |

As is evident from the data set forth in table 2B, the polishing performance of the composition is not significantly impacted by low level additions of the supplemental molybdenum etch inhibitor. In particular, the molybdenum, TEOS, and SiN removal rates are essentially unchanged. The tungsten removal rate shows a modest decrease, particularly at six ppm AEP and above.

### Example 3

Four polishing compositions were prepared. This example demonstrates that polishing compositions including stabilized colloidal silica and supplemental molybdenum etch inhibitor are colloidally stable. Each composition was intended to be a six times concentrate and included 2670 ppm by weight malonic acid, 1236 ppm by weight ferric nitrate nonahydrate (Fe(NO₃)₃·9H₂O), 24 ppm by weight epsilon poly-L-lysine, 120 ppm by weight L-histidine, 12 ppm aminoethyl piperazine, 100 ppm by weight Proxel AQ preservative, an amount of tetrabutylammonium hydroxide, and 0.2 weight percent of a colloidal silica having a particle size of about 130 nm. The pH of each composition was adjusted to 2.15 using nitric acid or potassium hydroxide. The amounts of tetrabutylammonium hydroxide (TBAH) are shown in Table 3 along with the conductivity, particle size, and zeta potential of each composition. The particle size and zeta potential measurements were made using a Zetasizer® (Malvern Instruments).

TABLE 3

| | | | Particle | Zeta |
|---|---|---|---|---|
| Polishing | TBAH | Conductivity | Size | Potential |
| Composition | (ppm) | (μS/cm) | (nm) | (mV) |
| 3A | 900 | 3878 | 130 | 19 |
| 3B | 1350 | 3549 | 131 | 21 |
| 3C | 1800 | 4310 | 127 | 20 |
| 3D | 2700 | 4286 | 126 | 22 |

As is evident from the data set forth in table 3, the addition of AEP does not negatively impact the colloidal stability of polishing compositions including TBAH stabilized colloidal silica.

### Example 4

Four polishing compositions were prepared. This example demonstrates the effectiveness the disclosed substituted piperazine as supplemental molybdenum etch inhibitors. Each composition included 445 ppm by weight malonic acid, 206 ppm by weight ferric nitrate nonahydrate (Fe(NO₃)₃·9H₂O), 4 ppm by weight epsilon poly-L-lysine, 20 ppm by weight L-histidine, 0.17 cationic weight percent of a cationic colloidal silica that was treated with an amino silane compound, 16 ppm by weight Proxel AQ preservative, and 0.5 weight percent hydrogen peroxide. The pH of each composition was adjusted to 2.15 using nitric acid or potassium hydroxide. Compositions 4B-4D further included 0.5 mM of a supplemental molybdenum etch inhibitor. Composition 4B included 0.5 mM (43 ppm) piperazine (PIP). Composition 4C included 0.5 mM (64 ppm) aminoethyl piperazine (AEP). Composition 4D included 0.5 mM (100 ppm) 1,4-Bis(3-aminopropyl)piperazine (PAZ).

The static etch rates of tungsten and molybdenum were measured for each of the above compositions. The static etch rate of tungsten was measured by immersing one inch square wafer samples (cleaved from 8 inch diameter blanket wafers having an initial W thickness of 8 kÅ) in the respective compositions (tungsten side up) for 5 minutes at 60 degrees C. The static etch rate of molybdenum was measured by immersing one inch square wafer samples (cleaved from 12 inch diameter blanket wafers having an initial Mo thickness of 2 kÅ) in the respective compositions (molybdenum side up) for 30 seconds at 25 degrees C. The SER values are reported in Table 4. Each SER value is the average of two measurements.

TABLE 4

| Polishing | Supplemental Etch | W SER Rate | Mo SER Rate |
|---|---|---|---|
| Composition | Inhibitor (0.5 mM) | (Å/min) | (Å/min) |
| 4A | None | 79 | 1265 |
| 4B | Piperazine | 119 | 417 |
| 4C | Aminoethyl Piperazine | 54 | 70 |
| 4D | 1,4-Bis(3- | 41 | 3 |
| | aminopropyl)piperazine | | |

As is evident from the data set forth in Table 4, the aminoethyl piperazine and 1,4-Bis(3-aminopropyl)piperazine supplemental molybdenum etch inhibitors reduce the etch rate of W and significantly reduce the etch rate of molybdenum at high inhibitor concentrations. In contrast, piperazine increases the etch rate of W and only modestly reduces the etch rate of molybdenum (even at the high concentrations tested).

### Example 5

Six polishing compositions were prepared. This example demonstrates that small additions of 1,4-Bis(3-aminopropyl)piperazine (PAZ) as supplemental molybdenum etch inhibitor do can provide suitable tungsten and molybdenum removal while also providing improved corrosion protection of molybdenum. Each of the polishing compositions included an amino-silane treated, cationic colloidal silica having an average particle size of about 100 nm, 445 ppm by weight malonic acid, 206 ppm by weight ferric nitrate nonahydrate (Fe(NO₃)₃·9H₂O), 4 ppm by weight epsilon poly-L-lysine, 20 ppm by weight L-histidine, 16 ppm by weight Proxel AQ preservative, and 1.0 wt. % hydrogen peroxide. The pH of each composition was adjusted to 2.7 or 3.2 as set forth in Table 5A below, using nitric acid or potassium hydroxide. The amounts of the cationic colloidal silica and 1,4-Bis(3-aminopropyl)piperazine (PAZ) and pH values are listed in Table 5A.

The CMP performance of polishing compositions 5A-5F was evaluated using a Reflexion® CMP polishing tool (Applied Materials) with an VP6000 polishing pad (DuPont) and in-situ conditioning using a Saesol AK45 conditioner at 4 lbs. Tungsten, molybdenum, TEOS, and SiN polishing rates were obtained by polishing corresponding 300 mm blanket wafers at a downforce of 1.0 psi, a platen speed of 83 rpm, a head speed of 73 rpm, and a slurry flow rate was 250 mL/min. Blanket wafer polishing rates (removal rates) are shown in Table 5B.

TABLE 5A

| Polishing | Colloidal Silica | | PAZ |
|---|---|---|---|
| Composition | (wt. %) | pH | (ppm) |
| 5A | 0.17 | 2.7 | 0 |
| 5B | 0.17 | 3.2 | 0 |
| 5C | 0.17 | 2.7 | 1 |
| 5D | 0.17 | 3.2 | 1 |
| 2E | 0.17 | 2.7 | 3 |
| 2F | 0.17 | 3.2 | 3 |

TABLE 5B

| Polishing | W RR | Mo RR | TEOS RR | SiN RR |
|---|---|---|---|---|
| Composition | (Å/min) | (Å/min) | (Å/min) | (Å/min) |
| 5A | 673 | 614 | 18 | 13 |
| 5B | 595 | 569 | 15 | 4 |
| 5C | 553 | 493 | 18 | 4 |
| 5D | 451 | 534 | 25 | 5 |
| 5E | 225 | 342 | 20 | 5 |
| 5F | 187 | 354 | 20 | 5 |

The static etch rates of tungsten and molybdenum were measured for each of the above compositions. The static etch rate of tungsten was measured by immersing one inch square wafer samples (cleaved from 8 inch diameter blanket wafers having an initial W thickness of 8 kÅ) in the respective compositions (tungsten side up) for 5 minutes at 45 degrees C. The static etch rate of molybdenum was measured by immersing one inch square wafer samples (cleaved from 12 inch diameter blanket wafers having an initial Mo thickness of 2 kÅ) in the respective compositions (molybdenum side up) for 30 seconds at 25 degrees C. The SER values are reported in Table 5C. Each SER value is the average of two measurements.

TABLE 5C

| Polishing | W SER | Mo SER |
|---|---|---|
| Composition | (Å/min) | (Å/min) |
| 5A | 49 | 2594 |
| 5B | 54 | 2113 |
| 5C | 47 | 2290 |
| 5D | 53 | 1650 |
| 5E | 53 | 781 |
| 5F | 54 | 568 |

The data show that the inventive compositions with PAZ can provide suitable CMP removal rates, particularly for Molybdenum CMP, while improving protection of molybdenum metal. For example, inventive composition 5D (534 Ang/min) has Mo CMP removal capability near (94% of the value) to the comparative 5B (569 Ang/min), while the inventive composition with even 1 ppm of the inventive piperazine provided improved Mo protection (ca 22% reduction in Mo SER). The W SER values are all unchanged within experimental error.

### Example 6

Three polishing compositions were prepared. This example demonstrates that the inventive compositions can be applied to metals buffing formulations to provide suitable metals removal rates in the absence of a metal accelerator such as the iron nitrate nonahydrate. The polishing compositions are set forth in Table 6A. The polishing compositions were prepared by mixing tetrabutylammonium hydroxide (500 ppm) with glycine (1600 ppm) and Kordek MLX (100 ppm) with a permanently charged cationic silica (3%) with an approximate size of 50 nm and adjusting the pH value to 2.4 with nitric acid. All of the polishing compositions were used with 0.5% H₂O₂ for the CMP experiments. The polishing compositions are set forth in Table 6A.

TABLE 6A

| Polishing Composition | AEP (ppm) |
|---|---|
| 6A | 0 |
| 6B | 50 |
| 6C | 100 |

The CMP performance of polishing compositions 6A-6C was evaluated using a AP200 CMP polishing tool (LNS) adapted for polishing square coupons (ca 3 sq in) with a Fujibo H804 pad and a 3M-A189L conditioner (3M) ex situ (6 lbs). Tungsten, TEOS, and SiN polishing rates were obtained by polishing corresponding blanket coupons in duplicate at a downforce of 2.0 psi, a platen speed of 123 rpm, a head speed of 117 rpm. Blanket wafer polishing rates (removal rates) are shown in Table 6B.

TABLE 6B

| Polishing | W RR | TEOS RR | SiN RR |
|---|---|---|---|
| Composition | (Å/min) | (Å/min) | (Å/min) |
| 6A | 285 | 188 | 36 |
| 6B | 336 | 175 | 39 |
| 6C | 344 | 180 | 43 |

This example shows that the inventive formulations can provide comparable selectivity profiles to the comparative example 6A in the absence of iron catalyst and stabilizer. The inventive compositions provide higher tungsten removal rate capability than the comparative example without AEP.

It will be understood that the recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A chemical mechanical polishing composition comprising:
a liquid carrier;
abrasive particles dispersed in the liquid carrier;
optionally, an iron-containing accelerator;
optionally, a stabilizer bound to the iron-containing accelerator;
at least one inhibitor of tungsten etching, the inhibitor of tungsten etching including at least one nitrogen containing group; and
a substituted piperazine compound.

2. The composition of claim 1, wherein the substituted piperazine compound is substituted with at least one straight-chain, alkyl amine group having 1, 2, or 3 carbon atoms.

3. The composition of claim 1, wherein the substituted piperazine compound comprises aminoethylpiperazine, 1,4-Bis(3-aminopropyl)piperazine, or a mixture thereof.

4. The composition of claim 1, comprising from about 0.5 ppm to about 10 ppm by weight of the substituted piperazine compound.

5. The composition of claim 1, comprising from about 1 ppm to about 5 ppm by weight of the substituted piperazine compound.

6. The composition of claim 1, further comprising a hydrogen peroxide oxidizer.

7. The composition of claim 1, having a pH in a range from about 1 to about 4.

8. The composition of claim 1, wherein the iron-containing accelerator comprises a soluble iron catalyst and the stabilizer comprises a dicarboxylic acid stabilizer bound to the soluble iron catalyst.

9. The composition of claim 1, wherein the at least one inhibitor of tungsten etching comprises a polyamino acid compound.

10. The composition of claim 1, wherein the at least one inhibitor of tungsten etching comprises an amino acid compound.

11. The composition of claim 1, wherein the inhibitor of tungsten etching comprises first and second distinct inhibitors of tungsten etching.

12. The composition of claim 11, wherein the first inhibitor of tungsten etching comprises a polyamino acid compound, and the second inhibitor of tungsten etching comprises an amino acid compound.

13. The composition of claim 1, wherein the abrasive particles comprise cationic colloidal silica particles.

14. The composition of claim 13, wherein the cationic colloidal silica particles comprise an amino silane compound bonded to an external surface thereof.

15. The composition of claim 13, further comprising a cationic surfactant selected from tetrabutylammonium, tetrapentylammonium, tetrabutylphosphonium, tributylmethylphosphonium, tributyloctylphosphonium, benzyltributylammonium, and mixtures thereof.

16. The composition of claim 1, wherein the abrasive particles comprise anionic colloidal silica particles or anionic alumina particles and the composition further comprises an anionic polymer.

17. The polishing composition of claim 1, wherein:
the abrasive particles comprise cationic colloidal silica particles;
the iron-containing accelerator is present and comprises a soluble iron catalyst, and the stabilizer is present and comprises a dicarboxylic acid stabilizer bound to the soluble iron catalyst;
the inhibitor of tungsten etching comprises a polyamino acid compound and an amino acid compound;
the substituted piperazine compound comprises from about 1 ppm by weight to about 5 ppm by weight of aminoethylpiperazine, 1,4-Bis(3-aminopropyl)piperazine, or a mixture thereof; and
the polishing composition has a pH in a range from about 1 to about 4.

18. A method of chemical mechanical polishing a substrate, the method comprising:
(a) contacting the substrate with the polishing composition of claim 1;
(b) moving the polishing composition relative to the substrate; and
(c) abrading the substrate to remove a portion of at least one molybdenum layer from the substrate and thereby polish the substrate.

19. The method of claim 18, wherein abrading the substrate in (c) removes a portion of at least one molybdenum layer and a portion of at least one tungsten layer from the substrate to thereby polish the substrate.

20. The method of claim 19, wherein the at least one molybdenum layer and at the least one tungsten layer contact one another in the substrate.
